(19) United States
(12) Patent Application Publication
(10) Pub. No.: US 2003/0176891 A1
(43) Pub. Date: Sep. 18, 2003

(54) Pacifier

(76) Inventor: Gabrielle Frederic, St. Louis, MO (US)

Correspondence Address: Joseph E. Walsh, Jr., Harness, Dickey & Pierce, P.L.C., 7700 Bonhomme, Suite 400, St Louis, MO, 63105, US

(21) Appl. No.: 10/098,899

(22) Filed: Mar. 15, 2002

(51) Int. Cl. A61J 17/00

(52) U.S. Cl. 606/234

(57) ABSTRACT

A pacifier providing a mouthpiece with a liquid-receiving cavity for easy replacement and re-filling of the liquid therein. A sealing connection with a mouth guard is provided to allow for holding of the liquid in the cavity of the mouthpiece. The mouthpiece of the pacifier may include a plurality of protrusions extending from the mouthpiece.

### FIELD OF THE INVENTION

The present invention relates generally to pacifiers, and more particularly, to a two-piece pacifier having a cavity therein.

### BACKGROUND OF THE INVENTION

It is a common to use what is generally known as a pacifier to satisfy the sucking and chewing instinct of an infant. Most pacifiers include a nipple portion that is placed in the mouth of the infant, a mouth guard for preventing the accidental swallowing of the pacifier by the infant, and a handle by which the pacifier can be held or maneuvered.

As infants progress to toddlers, many infants experience teething pains that may be soothed by a pacifier. During this teething period, an infant's gums may become sore and inflamed as the new teeth break through the surface of the skin on the gums. Different types of pacifiers are known and specifically designed to stimulate and massage the gums to alleviate the pain and discomfort associated with the infant's teething process. Such pacifiers include, for example, teething devices or teething rings, depending on the shape of the device.

Teething rings or devices are believed to be particularly soothing if the portion of the teething device on which the infant chews is composed of a semi-hard material and incorporates small protrusions (e.g., nodules) that aid in the stimulation of the gums. Generally, the pain and discomfort associated with teething can be alleviated by application of something cold to the inflamed gums of the infant and, thus, placing a teething device in an extremely cold environment, such as a freezer, before insertion into the child's mouth is relatively common.

Various devices also exist in which a liquid has been provided within either a pacifier or a particular teething device during manufacture of the devices. The devices may then be subjected to a range of temperatures so as to provide pain relief when inserted into the mouth of the infant and against the gums of the infant.

In such devices having a liquid therein, a predetermined type and amount of liquid is typically provided in the devices and permanently sealed therein. As such, the liquid sealed within the device cannot be changed, extracted, or replaced without substantially compromising the integrity of the seal and the device as a whole. In fact, it is virtually impossible to replace such liquid. As a result, if the liquid does breach the seal(s) and escapes from the device, the device is commonly rendered useless. Further, such devices do not allow for removal of liquid that may be stale, detrimental to the health and welfare of the infant, or otherwise harmful.

### SUMMARY OF THE INVENTION

The inventor has perceived a need for a pacifier that allows flexibility with respect to the selection and changing of fluids within the pacifier which allows flexibility in the levels and type of liquid, and which provides for a longer and more useful life of the pacifier. Further, it is desirable that the pacifier comprises a mouthpiece and a cap portion adapted for removable sealing engagement to allow easy access to a cavity for filling with a particular type or amount of liquid as desired or needed, and for replacement of the liquid.

The present invention provides a pacifier having a mouthpiece and a cap adapted for sealing engagement to the mouthpiece. In particular, the mouthpiece includes a cavity that extends substantially throughout the interior of the mouthpiece and is accessible through an opening in the mouthpiece.

The mouthpiece may also include various protrusions (e.g., nodules) extending outwardly from the exterior of the mouthpiece. The mouthpiece may be constructed as a generally cylindrical body that is configured in an arcuate shape. Such arcuate shape is designed to align the teeth of the infant with the mouthpiece of the pacifier. Other shapes of the mouthpiece are also possible and are within the purview of this invention.

The mouthpiece of the pacifier provides a generally cylindrical shaft extending from the mouthpiece. This generally cylindrical shaft is configured for connection with the cap of the pacifier to allow for sealing a liquid therein. Further, the cavity of the mouthpiece is accessible through an opening at the end of the cylindrical shaft adapted for attachment to the mouth guard. The mouthpiece and cap include complementary means of connection that can be provided in a variety of different ways.

The cap of the pacifier preferably includes a mouth guard with a handle. The mouth guard preferably includes a hard or semi-hard protective shield that is concave to fit the contour of the areas surrounding a child's mouth. In particular, the mouth guard is preferably configured in size and shape to prevent an infant from choking on or swallowing the pacifier.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an elevation view of a pacifier constructed according to the principles of the present invention.

FIG. 2 is a side elevation view of the pacifier of FIG. 1.

FIG. 3 is a bottom plan view of the pacifier of FIG. 1.

FIG. 4 is an exploded elevation view of the pacifier of FIG. 1.

FIG. 5 is an exploded cross-sectional view of the pacifier of FIG. 3 taken along the line of 3-3.

FIGS. 6A-6C are perspective views showing exemplary ornamental components of a pacifier of the present invention.

### DETAILED DESCRIPTION OF THE PREFERRED EMBODIMENTS

The following description of the preferred embodiments is merely exemplary in nature and is in no way intended to limit the invention, its application or uses. Thus, although the present invention is described in connection with specific configurations for a pacifier and component parts, it is not so limited and different configurations are contemplated.

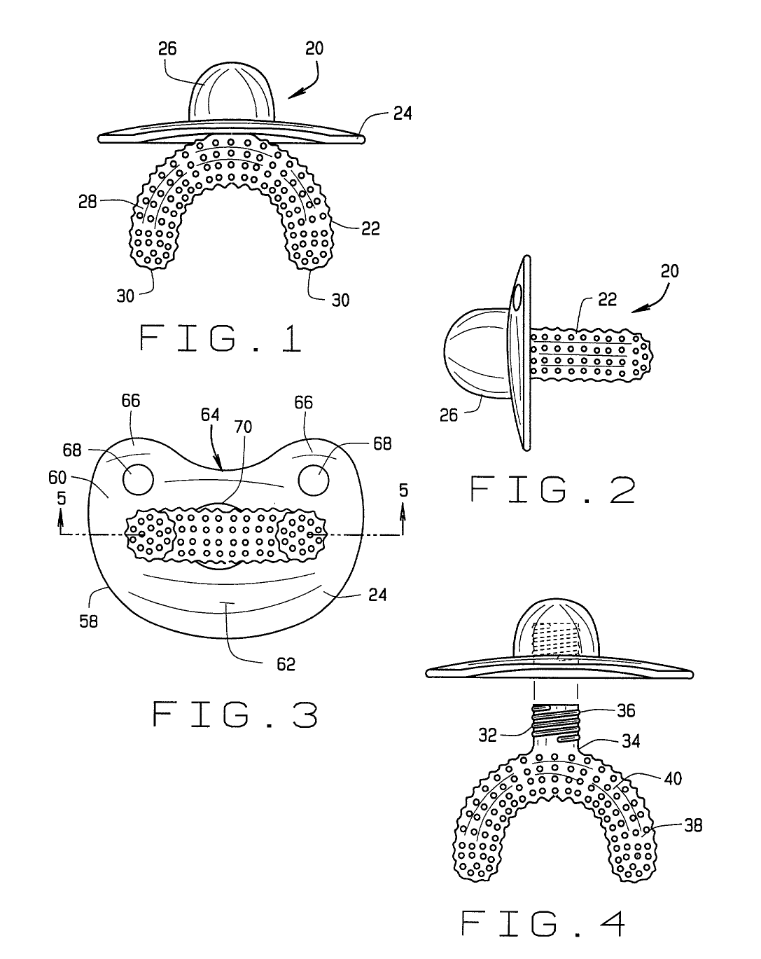

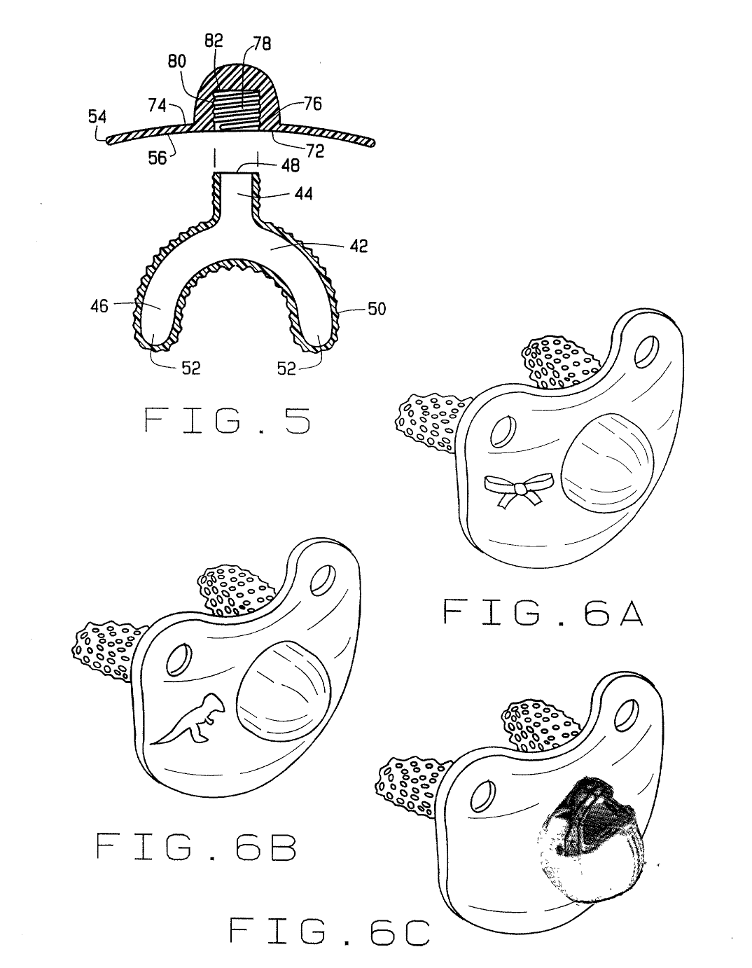

FIGS. 1 through 6 show one preferred embodiment of a pacifier constructed according to the principles of the present invention and generally noted by the numeral 20. The pacifier 20 generally includes a mouthpiece 22 and a mouth guard 24 with a handle 26 attached thereto.

As shown in one exemplary form, the mouthpiece 22 includes a generally cylindrical body 28 configured in an arcuate shape such that the generally cylindrical body is sealed at opposing ends 30 of the generally cylindrical body 28.

The mouthpiece 22 also includes a generally cylindrical shaft 32 that extends from approximately the mid-section 34 of the generally cylindrical body. The generally cylindrical shaft 32 includes a thread or series of threads 36 that extend circumferentially around an outer surface 37 of the generally cylindrical shaft 32. It should be noted that other connection members may be provided on the outer surface of the generally cylindrical shaft.

An outer surface of the generally cylindrical body 28 includes a plurality of protrusions (e.g., nodules) 38 that extend generally outwardly from the outer surface 39 of the generally cylindrical body 28. As shown, the protrusions 38 are arranged with even spacing along the entire outer surface 39 of the generally cylindrical body. It should be noted that the protrusions 38 may be configured in different arrangements (e.g. uneven spacing) along the outer surface 39 and may be provided in different shapes and sizes.

Both the generally cylindrical body 28 and the generally cylindrical shaft 32 include a continuous cavity 42. The cavity 42 extends substantially throughout an inner portion 44 of the generally cylindrical body 28 including the generally cylindrical shaft 32, as shown in more detail in FIG. 5. The cavity 42 is accessible through an opening 48 of the generally cylindrical shaft 32. The mouthpiece 22 is preferably constructed such that the opening 48 is the only access point to the cavity 42. In one preferred embodiment, the cavity 42 is integrally formed within the mouthpiece 22 which may be constructed of rubber, extruded plastic or any other suitable material. It should be noted that the mouthpiece 22 may be formed as a single piece or as multiple pieces sealed together.

With respect to the mouth guard 24, and as shown more clearly in FIGS. 1-6, the mouth guard 24 is constructed as a generally concave shield 54 having an outer edge 56 of a predetermined width. The mouth guard 24 is constructed such that the circumference 58 of the mouth guard 24 is generally larger than can fit inside the mouth of the intended user. As such, the mouth guard 24 is configured to cover the lips and area of the face surrounding the lips when the mouthpiece 22 is inserted into the mouth of the intended user. The mouth guard 24 has a top portion 60 and bottom portion 62, with the top portion 60 having a curved depression 64 to fit under the nose of the intended user. The top portion 60 may also include holes 68 to allow sufficient ventilation to the user. It should be noted that vent holes (not shown) may also be provided in other locations on the mouth guard 24.

The mouth guard 24 includes an opening 70 that exists at about the center of the mouth guard 24. The opening 70 of the mouth guard 24 provides for connection with the generally cylindrical shaft 32 of the mouthpiece 22. The opening 70 is configured with a diameter to be of approximately the same diameter of the generally cylindrical shaft 32.

A cavity 78 within the handle 26 of the mouth guard 24, which is accessible through the opening 70, includes complementary grooves 80 for receiving the threads 36 of the generally cylindrical shaft 32. This provides for locking engagement of the mouthpiece 22 to the mouth guard 24. It should be noted that other types of complementary connections between the mouth piece 22 and mouth guard 24 may be provided. For example, a bayonet connector, a spring-loaded connection, a keyed connection or other suitable connections are contemplated and may be provided.

In the preferred construction, as shown in FIGS. 1-6, the pacifier 20 is constructed having approximately the following dimensions:

Mouth piece 20—½″ tall by 1⅝″ wide by 1⅝″ deep;

Generally cylindrical body 22—½″ tall by 1⅝″ wide by 1⅛″ deep;

Generally cylindrical shaft 34—½″ tall by ½″ wide by ½″ deep;

Mouth guard 24 with handle 26—1⅝″ tall by 2¼″ wide by ¾″ deep;

Holes 68—¼″ diameter;

Accessible opening 70—½″ diameter and 9/16″ deep.

The pacifier 20 may also include distinguishing ornamental components or features such as, for example, a colored bow or ribbon (e.g., blue for boy and pink for girl), a rattle or other distinguishing characteristic (e.g., an emblem, a picture, a college mascot, a logo of a professional sports team or other such marks, nameplates, etc.), such that the pacifier 20 may be identified with a particular gender or other desired classification, association or affiliation.

In operation, and as shown in FIGS. 1-6, a pacifier 20 of the present invention allows for removable connection of a mouthpiece 22 having a cavity 42 therein to a mouth guard 24 with a handle 26 to provide a seal between the mouthpiece 22 and the mouth guard 24. Further, the cavity 42 of mouthpiece 22 may be filled with a type and amount of liquid and sealed therein by connection of the mouthpiece 22 with the mouth guard 24. In addition, the liquid may be removed from the cavity 42 by disconnecting the mouthpiece 22 from the mouth guard 24. For example, the mouthpiece may be filled with a type and amount of liquid and connected to the mouth guard 24 by engagement of the threads 36 of the mouthpiece 22 with the grooves 80 of the mouth guard 24. The mouthpiece 22 and mouth guard 24 may be screwed together to provide a sealing connection and hold a liquid therein. The mouthpiece 22 and mouth guard 24 then may be disconnected by unscrewing the mouthpiece 22 and the mouthpiece 24 to disengage the complimentary threads 36 and grooves 80 so as to provide access to the cavity 42 of the mouthpiece 22 to replace or hold the liquid therein.

Although a pacifier 20 of the present invention is configured having a particular sealing engagement, other configurations and sealing engagements are contemplated depending upon the particular application and connections needed or desired.

The foregoing description of the invention is exemplary and not exhaustive in nature. Thus, variations that do not depart from the gist of the invention are intended to be within the scope of the invention. Such variations are not to be regarded as a departure from the spirit and scope of the invention.

What is claimed is:

1. A pacifier comprising:
a mouthpiece having a cavity therein accessible through an opening; and
a cap adapted for a sealing engagement with the mouthpiece to seal the opening.

2. A pacifier according to claim 1, wherein the cavity encompasses a substantial portion of the mouthpiece.

3. A pacifier according to claim 2, wherein the mouthpiece comprises an engagement means for connection with the cap.

4. A pacifier according to claim 3, wherein the mouthpiece comprises an engagement means for connection with the engagement means of the cap.

5. A pacifier according to claim 4, wherein the engagement means of the cap is configured for connection with the engagement means of the mouthpiece to provide the sealing engagement.

6. A pacifier according to claim 5, wherein the sealing engagement of mouthpiece and cap provide a liquid-tight seal.

7. A pacifier according to claim 6, wherein the engagement comprises a threaded portion to provide connection with the engagement means of the cap.

8. A pacifier according to claim 7, wherein the engagement means of the cap comprises a complimentary grooved portion to provide connection with the engagement means of the mouthpiece.

9. A pacifier according to claim 8, wherein the cap comprises a mouth guard and handle.

10. A pacifier according to claim 9, wherein the mouthpiece comprises a generally cylindrical body having an arcuate shape.

11. A pacifier according to claim 10, wherein a cavity comprises a substantial portion of an interior of the generally cylindrical body.

12. A pacifier according to claim 11, wherein the generally cylindrical body includes a generally cylindrical shaft extending from the generally cylindrical body and including the engagement means for the mouthpiece for connecting to engagement means of the cap.

13. A pacifier according to claim 12, further comprising a plurality of protrusions on an exterior of the mouthpiece and extending generally outwardly from an exterior of the mouthpiece.

14. A pacifier according to claim 13, wherein the plurality of protrusions are evenly spaced on the exterior of the mouthpiece.

15. A pacifier according to claim 13, wherein the plurality of protrusions are unevenly spaced.

16. A pacifier according to claim 15, wherein the mouthpiece is composed of a pliable material.

17. A pacifier according to claim 16, wherein at least one distinguishing ornamental component is provided on the pacifier.

18. A two-piece pacifier for receiving a liquid therein comprising: an arcuate mouthpiece having a cavity therein for receiving fluid through an opening and a cap portion adapted for removable connection with the mouthpiece to provide sealing engagement therewith.

19. The two-piece pacifier according to claim 18, wherein an outer surface of the mouthpiece comprises a plurality of protrusions.

20. A method of providing a pacifier adapted to receive a liquid therein and capable of replacement of the liquid therein, the method comprising configuring a mouthpiece with a cavity therein for receiving the liquid and configuring a cap for sealing engagement with the mouthpiece for sealing liquid in the mouthpiece.

21. The method according to claim 20 further comprising forming the mouthpiece in an arcuate shape.

22. The method according to claim 21 further comprising providing a plurality of protrusions on an outer surface of the mouthpiece.
